(19) United States
(12) Patent Application Publication
(10) Pub. No.: US 2021/0107252 A1
(43) Pub. Date: Apr. 15, 2021

(54) OPTICAL LAMINATE ROLL

(71) Applicant: NITTO DENKO CORPORATION, Ibaraki-shi, Osaka (JP)

(72) Inventors: Shoichi Kawamitsu, Ibaraki-shi, Osaka (JP); Takeshi Murashige, Ibaraki-shi, Osaka (JP); Junichi Inagaki, Ibaraki-shi, Osaka (JP); Minoru Miyatake, Ibaraki-shi, Osaka (JP); Kazutaka Hara, Ibaraki-shi, Osaka (JP); Makoto Miyamoto, Ibaraki-shi, Osaka (JP)

(73) Assignee: NITTO DENKO CORPORATION, Ibaraki-shi, Osaka (JP)

(21) Appl. No.: 16/965,087

(22) PCT Filed: Jan. 23, 2019
(86) PCT No.: PCT/JP2019/002151

§ 371 Date: Jul. 27, 2020

(30) Foreign Application Priority Data
Jan. 31, 2018 (JP) 2018-015369

(51) Int. Cl. B32B 7/023; B32B 1/08; B32B 7/12; B32B 17/06; B32B 7/06; G02B 5/30; G02B 1/11; G02B 1/18; G02B 1/16; G02B 1/14

(52) U.S. Cl. CPC B32B 7/023; B32B 1/08; B32B 7/12; B32B 17/06; B32B 7/06; G02B 5/3033; B32B 2307/412; G02B 1/18; G02B 1/16; G02B 1/14; B32B 2250/05; B32B 2307/42; B32B 2551/00; G02B 1/11

(57) ABSTRACT

Disclosed is an optical laminate roll formed of a long optical laminate including a glass layer. In the optical laminate roll, the optical laminate includes a flexible glass layer (10), a polarize (30) and a pressure sensitive adhesive layer (80). The thickness of the glass layer is preferably 150 μm or less. The length of the optical laminate roll is preferably 100 m or more. In the optical laminate, the polarizer and the adhesive layer may be arranged in this order on a first principal surface of the glass layer. A transparent film may be disposed between the glass layer and the polarizer.

### TECHNICAL FIELD

The present invention relates to a roll of a long optical laminate including a flexible glass layer

### BACKGROUND ART

Display devices such as a liquid crystal display element and an organic light emitting diode (OLED) element have been becoming lighter and thinner. For information terminals such as smartphones and tablet PCs, not only the demand for weight reduction and thickness reduction, but also demand for improvement of impact resistance has been growing. In many cases, a transparent protecting material (front window) is disposed on the surface of a display region.

As the protecting material, a glass plate or a plastic plate is used. The glass plate has high hardness, and is suitable for securing the impact resistance of the device. In addition, since glass has high transparency and surface gloss, use of a glass plate as a front window enables attainment of high visibility with a glare feeling. However, glass has a high specific gravity, and therefore contributes to hindrance to weight reduction of the device. A plastic plate is lighter than a glass plate, but impact resistance and transparency which are as high as those of the glass plate are difficult to attain with the plastic plate.

Patent Document 1 suggests that a glass layer having flexibility is used for a front window of an image display device to secure both the lightness and the impact resistance of the device.

### PRIOR ART DOCUMENTS

### Patent Documents

Patent Document 1: WO 2013/028321

### SUMMARY OF THE INVENTION

### Problems to be Solved by the Invention

A flexible glass layer can be applied to a roll-to-roll process, and therefore can be expected to contribute to improvement of productivity as well as weight reduction of a device. In addition, by using an optical laminate in which a glass layer having flexibility is laminated to a polarizer in advance, bonding of the polarizer to an image display cell and attachment of a front window to a surface of an image display device can be performed by one bonding operation.

However, a flexible glass layer is easily broken by bending, and at present, an optical laminate including a long flexible glass layer has not been obtained, and knowledge on practical use of the optical laminate is not silent.

### Means for Solving the Problems

The present invention relates to a roll of an optical laminate including a flexible glass layer and a polarizer. The length of the optical laminate forming the roll is preferably 100 m or more.

The optical laminate includes a flexible glass layer, a polarizer and a pressure sensitive adhesive layer. A separator may be temporarily attached to a surface of the pressure sensitive adhesive layer. The optical laminate may further include a transparent film. The thickness of the glass layer is preferably 150 μm or less.

In an optical laminate roll according to a first embodiment of the present invention, an optical laminate includes a polarizer and a pressure sensitive adhesive layer in this order on a first principal surface of the glass layer. A transparent film may be disposed between the glass layer and the polarizer. An optically anisotropic film such as an obliquely stretched quarter wave plate may be used as the transparent film. The transparent film may be an optically isotropic film.

An optically isotropic or optically anisotropic transparent film may be disposed between the polarizer and the pressure sensitive adhesive layer. The transparent film arranged between the polarizer and the pressure sensitive adhesive layer may have functions of preventing reflection of external light in an OLED display, ensuring optical properties in a liquid crystal display, and so on.

In an optical laminate roll according to a second embodiment of the present invention, an optical laminate includes a pressure sensitive adhesive layer arranged on a first principal surface of a glass layer, and a polarizer arranged on a second principal surface of the glass layer.

In an optical laminate roll according to a third embodiment of the present invention, an optical laminate includes a polarizer and a pressure sensitive adhesive layer arranged on a first principal surface of a glass layer, and a transparent film arranged on a second principal surface of the glass layer.

The optical laminate may include functional layers such as an antireflection layer, an antifouling layer, an antistatic layer and an easily-adhesive layer. A surface protective film may be temporarily attached to the second principal surface of the glass layer.

In the optical laminate, the width of the glass layer and the width of each of the resin films (such as a polarizer, a surface protective film and a separator) laminated on the glass layer may be the same or different. The width of at least one resin film laminated on the glass layer may be larger than the width of the glass layer, with the resin film protruding from both ends of the glass layer in a width direction. In addition, the width of the pressure sensitive adhesive layer laminated on the glass layer may be larger than the width of the glass layer, with the pressure sensitive adhesive layer protruding from both ends of the glass layer in the width direction. When a film or a pressure sensitive adhesive layer laminated to the glass layer protrudes from both ends of the glass layer in the width direction, the end surface of the glass layer is positioned inside the end surface of the optical laminate roll, and therefore physical contact with the end surface of the glass layer is limited, so that breakage of the glass layer from the end surface can be suppressed.

Crack extension preventing means may be disposed on a surface of the glass layer. As the crack extension preventing means, a tape including a resin film and an adhesive layer, or the like is used. For example, by bonding a tape as crack extension preventing means to both ends of the optical laminate in the width direction or portions near the width direction ends, breakage of the glass layer is suppressed, so that a long optical laminate can be stably obtained.

### Effects of the Invention

By using the optical laminate roll of the present invention, an image display device excellent in impact resistance can be manufactured with high production efficiency.

### BRIEF DISCRIPTION OF THE DRAWINGS

FIG. 1 is a sectional view showing an example of a stacking configuration of an optical laminate

FIG. 2 is a sectional view showing an example of a stacking configuration of an optical laminate

FIG. 3 is a sectional view showing an example of a stacking configuration of an image display device including an optical laminate.

FIG. 4 is a sectional view showing an example of a stacking configuration of an optical laminate.

FIG. 5 is a sectional view showing an example of a stacking configuration of an optical laminate

FIG. 6A is a plan view of an optical laminate having a decorative printed portion.

FIG. 6B is a sectional view of an optical laminate having a decorative printed portion.

FIG. 7 is a sectional view showing an example of a stacking configuration of an optical laminate including an optical laminate.

FIG. 8 is a sectional view showing an example of a stacking configuration of an optical laminate.

FIG. 9 is a sectional view showing an example of a stacking configuration of an optical laminate

FIG. 10A is a plan view of a long glass layer equipped with a tape on a surface thereof.

FIG. 10B is a sectional view of a long glass layer equipped with a tape on a surface thereof.

FIG. 11 is a sectional view showing an example of a stacking configuration of an optical laminate equipped with a tape on a surface thereof.

FIG. 12 is a sectional view showing an example of a stacking configuration of an optical laminate

FIG. 13 is a sectional view showing an example of a stacking configuration of an optical laminate including an optical laminate.

FIG. 14 is a sectional view showing an example of a stacking configuration of an optical laminate.

FIG. 15 is a sectional view showing an example of a stacking configuration of an optical laminate

FIG. 16 is a sectional view showing an example of a stacking configuration of an optical laminate including an optical laminate.

FIG. 17 is a sectional view showing an example of a stacking configuration of an optical laminate.

FIG. 18 is a sectional view showing an example of a stacking configuration of an optical laminate

FIG. 19 is a sectional view showing an example of a stacking configuration of an optical laminate including an optical laminate.

FIG. 21 is a sectional view showing an example of a stacking configuration of an optical laminate.

FIG. 22 is a sectional view showing an example of a stacking configuration of an optical laminate

FIG. 23 is a sectional view showing an example of a stacking configuration of an optical laminate including an optical laminate.

FIG. 24 is a sectional view showing an example of a stacking configuration of an optical laminate.

FIG. 25 is a sectional view showing an example of a stacking configuration of an optical laminate

FIG. 26 is a sectional view showing an example of a stacking configuration of an optical laminate including an optical laminate.

FIG. 27 is a sectional view showing an example of a stacking configuration of an optical laminate.

FIG. 28 is a sectional view showing an example of a stacking configuration of an optical laminate

FIG. 29 is a sectional view showing an example of a stacking configuration of an optical laminate including an optical laminate.

FIG. 30 is a sectional view showing an example of a stacking configuration of an optical laminate.

### MODE FOR CARRYING OUT THE INVENTION

An optical laminate roll of the present invention is obtained by winding a long optical laminate having a length of 100 m or more into a roll. The length of the optical laminate is preferably 300 m or more, more preferably 500 m or more, further preferably 700 m or more. The width of the optical laminate is, for example, 50 to 3000 mm, preferably 10 to 2000 mm. The optical laminate includes a flexible glass layer, a polarizer and a pressure sensitive adhesive layer.

### First Embodiment

In an optical laminate roll according to a first embodiment of the present invention, a glass layer is disposed on one principal surface of a laminate, and a pressure sensitive adhesive layer is disposed on the other principal surface. A polarizer is disposed between the glass layer and the pressure sensitive adhesive layer.

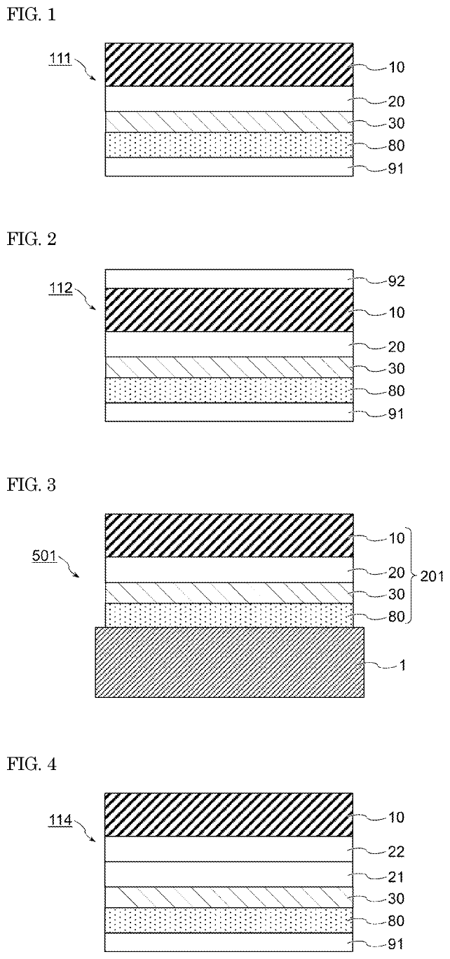

FIG. 1 is a sectional view showing an example of a stacking configuration of the optical laminate according to the first embodiment. An optical laminate 111 includes a transparent film 20, a polarizer 30 and a pressure sensitive adhesive layer 80 in this order on one principal surface of a glass layer 10. Hereinafter, a principal surface of the glass layer which is provided with the polarizer 30 (a surface on the image display cell side in formation of an image display device) is sometimes referred to as a first principal surface, and the opposite principal surface (a viewing-side surface in formation of an image display device) is sometimes referred to as a second principal surface.

A separator 91 is temporarily attached on a surface of the pressure sensitive adhesive layer 80. As shown in FIG. 2, an optical laminate 112 may have a surface protective film 92 temporarily attached on the glass layer 10.

FIG. 3 is a schematic sectional view of an image display device including an optical laminate. An image display device 501 includes an optical laminate 201 on a viewing-side surface of an image display cell 1. Examples of the image display cell include liquid crystal cells and OLED cells.

The optical laminate 201 is obtained by peeling and removing a separator temporarily attached on the pressure sensitive adhesive layer 80 of the optical laminate 111. The optical laminate 201 is attached to a surface of the image display cell 1 by the pressure sensitive adhesive layer 80. In an image display device 501, the glass layer 10 is disposed on a viewing-side surface, and has a function as a front window. Thus, it is not necessary to separately provide a front window.

<Glass Layer>

The glass layer 10 is a sheet-shaped glass material having flexibility. Examples of glass materials that form the glass layer include soda-lime glass, borate glass, aluminosilicate glass and quartz glass. The content of alkali metal components (e.g. Na₂O, K₂O and Li₂O) of the glass material is preferably 15% by weight or less, more preferably 10% by weight or less.

For imparting flexibility, the thickness of the glass layer 10 is preferably 150 μm or less, more preferably 120 μm or less, further preferably 100 μm or less. For imparting strength, the thickness of the glass layer is preferably 10 μm or more, more preferably 25 μm or more, further preferably 40 μm or more, especially preferably 50 μm or more.

The light transmittance of the glass layer 10 at a wavelength of 550 nm is preferably 85% or more, more preferably 90% or more. Similarly to a general glass material, the glass layer 10 has a density of about 2.3 to 3 g/cm³.

The method for forming the glass layer is not particularly limited, and any appropriate method can be employed. For example, a mixture containing a main raw material such as silica or alumina, an antifoaming agent such as sodium sulfate or antimony oxide, and a reducing agent such as carbon is melted at a temperature of 1400° C. to 1600° C., formed into a sheet shape, and then cooled to prepare a glass layer. Examples of methods for forming glass into a sheet shape include a slot down draw method, a fusion method and a float method. If necessary, the glass formed into a sheet shape may be subjected to a chemical treatment with a solvent such as hydrofluoric acid for the purpose of, for example, thinning and smoothing the glass sheet.

As the glass layer 10, commercially available thin glass may be used. Examples of the commercially available thin glass include “7059”, “1737” and “EAGLE2000” manufactured by Corning Incorporated., “AN100” manufactured by Asahi Glass Co., Ltd., “NA-35” manufactured by NH Techno Glass Corporation, “OA-10” manufactured by Nippon Electric Glass Company, Limited, and “D263” and “AF45” manufactured by Schott AG.

<Polarizer>

As the polarizer 30, a film which exhibits absorption dichroism at any wavelength in the visible light region is used. Sngle transmittance of the polarizer 30 is preferably 40% or more, more preferably 41% or more, further preferably 42% or more, especially preferably 43% or more. The polarization degree of the polarizer 30 is preferably 99.8% or more, more preferably 99.9% or more, further preferably 99.95% or more.

As the polarizer 30, any appropriate polarizer can be adopted according to a purpose. Examples thereof include hydrophilic polymer films such as polyvinyl alcohol-based films, partially formalized polyvinyl alcohol-based films and ethylene-vinyl acetate copolymer-based partially saponified films which are uniaxially stretched with a dichroic substance such as iodine or a dichroic dye adsorbed, and polyene-based oriented films such as dehydrated products of polyvinyl alcohol and dehydrochlorinated products of polyvinyl chloride. In addition, guest-host-type polarizers obtained by unidirectionally orienting a liquid-crystalline composition containing a dichroic substance and a liquid-crystalline compound as disclosed in U.S. Pat. No. 5,523,863 etc., E-type polarizers obtained by uniaxially orienting a lyotropic liquid crystal as described in U.S. Pat. No. 6,049,428 etc., and the like can be used.

Among these polarizers, polyvinyl alcohol-based (PVA)-based polarizers obtained by adsorbing a dichroic substance such as iodine or dichroic dye to a polyvinyl alcohol-based film such as a polyvinyl alcohol film or a partially formalized polyvinyl alcohol film, and uniaxially orienting the film are preferably used because these polarizers have a high polarization degree. For example, a PVA-based film is iodine-stained and stretched to obtain a PVA-based polarizer.

The thickness of the polarizer 30 is, for example, about 3 to 80 μm. The thickness of the polarizer 30 may be 5 μm or more. As the polarizer 30, a thin polarizer having a thickness of 25 μm or less, preferably 15 μm or less, more preferably 10 μm or less can be used. By using a thin polarizer having a thickness of about 3 to 25 μm, preferably about 5 to 10 μm a thin optical laminate can be obtained.

The thin polarizer is disclosed in, for example, Japanese Patent Laid-open Publication No. 51-069644, Japanese Patent Laid-open Publication No. 2000-338329, WO 2010/100917, Japanese Patent No. 4691205 and Japanese Patent 4751481. Such a thin polarizer is obtained by a manufacturing method including the steps of stretching a PVA-based resin layer and a resin substrate to be stretched, in a laminate state; and performing iodine staining.

<First Transparent Film>

The optical laminate 111 includes the transparent film 20 between the glass layer 10 and the polarizer 30. Lamination of the transparent film 20 to a surface of the polarizer 30 tends to improve the durability of the polarizer. In addition, provision of a transparent film between the glass layer and the polarizer tends to improve durability against impact from the surface of the glass layer.

The transparent film 20 may be an optically isotropic film having a front retardation of 5 nm or less, or may be an optically anisotropic film. The material of the transparent film 20 is not particularly limited. From the viewpoint of, for example, imparting durability to the polarizer and improving the impact resistance of the optical laminate, the material of the transparent film is preferably a resin material, and in particular, a thermoplastic resin excellent in transparency, mechanical strength, heat stability and moisture barrier property is preferably used. Specific examples of the resin include cellulose resins such as triacetyl cellulose, polyester-based resins, polyethersulfone resins, polysulfone resins, polycarbonate resins, polyamide resins, polyimide resins, polyolefin resins, (meth)acryl resins cyclic polyolefin resins (norbornene-based resins), polyarylate resins, polystyrene resins, polyvinyl alcohol resins and mixtures thereof.

In one embodiment, a (meth)acryl-based resin having a glutarimide structure is used as a material for the first transparent film disposed between the glass layer 10 and the polarizer 30. The (meth)acryl-based resin having a glutarimide structure is disclosed in, for example, Japanese Patent Laid-open Publication No. 2006-309033, Japanese Patent Laid-open Publication No. 2006-317560, Japanese Patent Laid-open Publication No. 2006-328329, Japanese Patent Laid-open Publication No. 2006-328334, Japanese Patent Laid-open Publication No. 2006-337491, Japanese Patent Laid-open Publication No. 2006-337492, Japanese Patent Laid-open Publication No. 2006-337493, Japanese Patent Laid-open Publication No. 2006-337569, Japanese Patent Laid-open Publication No. 2007-009182, Japanese Patent Laid-open Publication No. 2009-161744 and Japanese Patent Laid-open Publication No. 2010-284840. In particular, when the transparent film 20 is an optically isotropic film, use of a (meth)acryl-based resin having a glutarimide structure enables reduction of a retardation in the thickness direction in addition to a front retardation.

The thickness of the transparent film 20 is preferably 5 to 100 μm, more preferably 10 to 60 μm, further preferably 20 to 50 μm. The Young's modulus of the transparent film 20 at 23° C. is, for example, 0.5 to 10 GPa, preferably 1.5 to 10 GPa, more preferably 1.8 to 9 GPa. When the thickness and the Young's modulus of the transparent film are within the above-described ranges, the impact resistance of the optical laminate tends to be improved. The fracture toughness value of the transparent film 20 at 25° C. is, for example, 0.5 to 10 MPa m^{1/2}, preferably 1.5 to 10 MPa m^{1/2}, more preferably 2 to 6 MPa m^{1/2}. A transparent film, whose fracture toughness value falls within the above-described range, has sufficient toughness, and therefore can improve the flexibility of the optical laminate by reinforcing the glass layer 10 to suppress crack extension and breakage.

The transparent film 20 disposed between the glass layer 10 and the polarizer 30 may have ultraviolet absorbability. For example, when the transparent film contains an ultraviolet absorber, ultraviolet absorbability can be imparted. Examples of the ultraviolet absorber include oxybenzophenone-based compounds, benzotriazole-based compounds, salicylic acid ester-based compounds, benzophenone-based compounds, cyanoacrylate-based compounds, nickel complex salt-based compounds and triazine-based compounds. The content of the ultraviolet absorber in the transparent film 20 is preferably 0.01 to 10 parts by weight., more preferably 0.1 to 5 parts by weight, based on 100 parts by weight of the film

When the transparent film 20 has optical anisotropy, the in-plane slow-axis-direction refractive index nx, the in-plane fast-axis-direction refractive index ny and the thickness-direction refractive index nz can have various relationships. The optically anisotropic element can be a positive A plate satisfying the relationship of nx>ny=nz, a negative B plate satisfying the relationship of nx>ny>nz, a negative C plate satisfying the relationship of nx=ny>nz, a negative A plate satisfying the relationship of nz=nx>ny, a positive B plate satisfying the relationship of nz>nx>ny, or a negative C plate satisfying the relationship of nz>nx=ny. The optically anisotropic element may satisfy the relationship of nx>nz>ny.

In the optical laminate 111, the transparent film 20 is disposed on the viewing-side (the glass layer 10-side with the glass layer 10 being a front window) with respect to the polarizer 30. When the transparent film disposed on the viewing-side with respect to the polarizer is a quarter wave plate, and the slow axis direction of the quarter wave plate and the absorption axis direction of the polarizer 30 form an angle of about 45°, the transparent film and the polarizer form a circularly polarizing plate. In this case, linearly polarized light emitted from the image display cell 1 and transmitted through the polarizer 30 is converted into circularly polarized light by the quarter wave plate. Thus, an appropriate image can be viewed even by a viewer wearing polarization sunglasses.

The quarter wave plate has an in-plane retardation of 100 nm to 180 nm, preferably 110 nm to 170 nm, more preferably 120 nm to 130 nm, at a wavelength of 550 nm. The angle formed by the slow axis direction of the quarter wave plate and the absorption axis direction of the polarizer 30 is preferably 40 to 50°, more preferably 42 to 48°, further preferably 44 to 46°.

When the quarter wave plate as the transparent film 20 and the polarizer 30 form a circularly polarizing plate, the transparent, film 20 is preferably an obliquely stretched film. When the quarter wave plate is an obliquely stretched film having a slow axis in a direction at about 45° C. with respect to the longitudinal direction, a long optical laminate can be formed by roll-to-roll lamination with a polarizer or a glass layer. The oblique stretching can be performed by, for example, a tenter-type stretching machine that applies a feeding force, a tensile force or a take-up force at different speeds on the left and on the right in the transverse direction (TD) and/or the machine direction (MD).

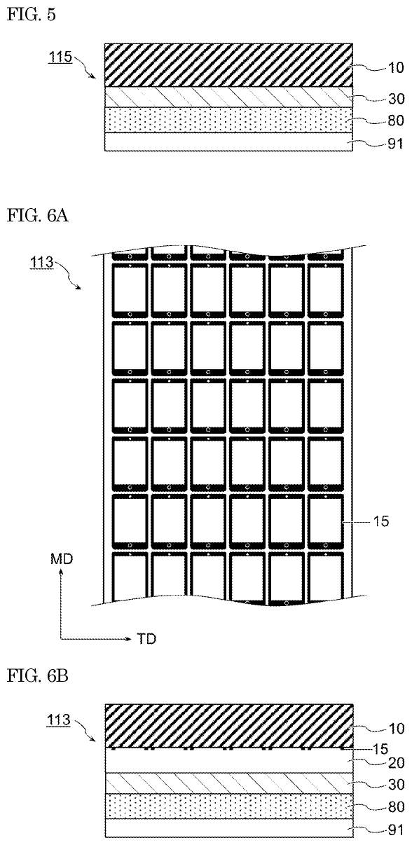

As shown in FIG. 4, the optical laminate may include two transparent films 21 and 22 between the glass layer 10 and the polarizer 30. For example, an optically isotropic film may be used as the transparent film 21 disposed adjacent to the polarizer 30, and an obliquely stretched quarter wave plate may be used as the transparent film 22 disposed the optically isotropic film.

By laminating a plurality of transparent films, optically anisotropic elements having various optically anisotropies can be obtained. For example, the wavelength dispersion of the transparent film can be adjusted by laminating films different in wavelength dispersion of the retardation such that the optical axis directions are mutually orthogonal (e.g. Japanese Patent Laid-open Publication No. 5-27118). In addition, the wavelength dispersion can be adjusted by laminating films different in retardation (e.g. half wave plate and quarter wave plate) in such a manner that optical axes are mutually non-parallel (e.g. Japanese Patent Laid-open Publication No. 10-68816).

The amount of change in retardation with a view angle may be adjusted by laminating films different in refractive index anisotropy. For example, by laminating a positive A plate (nx>ny≈nz) and a positive C plate (nz>nx≈ny), an optically anisotropic element can be obtained which has a refractive index satisfying the relationship of nx>nz>ny and has a small change in retardation with a view angle.

The first transparent film arranged between the glass layer 10 and the polarizer 30 may be a laminate of three or more layers. Instead of laminating a plurality of films, a layer of oriented liquid crystal molecules may be arranged on a transparent film to adjust the optical anisotropy

The optical laminate is not required to include a transparent film between the glass layer 10 and the polarizer 30. For example, as in an optical laminate 115 shown in FIG. 5, the glass layer 10 and the polarizer 30 may be disposed adjacent to each other

<Pressure Sensitive Adhesive Layer>

The pressure sensitive adhesive layer 80 is used for bonding the optical laminate to the image display cell 1. The pressure sensitive adhesive that forms the pressure sensitive adhesive layer 80 is not particularly limited, and one having an acryl-based polymer, a silicone-based polymer polyester, polyurethane, polyamide, polyether, a fluorine-based polymer, a rubber-based polymer or the like as a base polymer can be appropriately selected. In particular, the pressure sensitive adhesive is preferably one that is excellent in transparency, has moderate wettability, cohesiveness and adhesiveness, and is excellent in weather resistance, heat resistance and the like, such as an acryl-based pressure sensitive adhesive.

When the image display cell 1 is an OLED cell, the pressure sensitive adhesive layer 80 may have barrier properties against water and gases such as oxygen from the viewpoint of improving the life of the OLED element. When the pressure sensitive adhesive layer 80 has a water vapor barrier property; the moisture permeability of the pressure sensitive adhesive layer at 40° C. and 90% RH is preferably 200 g/m² 24 hr or less, more preferably 150 g/m² 24 hr or less, further preferably 100 g/m² 24 hr or less, especially preferably 50 g/m² 24 hr or less. For example, when a rubber-based pressure sensitive adhesive having a rubber-based polymer as a base polymer is used for the pressure sensitive adhesive layer 80, the barrier properties can be improved.

The pressure sensitive adhesive layer 80 may be a laminate of two or more layers. The thickness of the pressure sensitive adhesive layer 80 is, for example, about 1 to 300 μm, preferably 5 to 50 μm, more preferably 10 to 30 μm.

<Separator>

Preferably, a separator 91 is temporarily attached on a surface of the pressure sensitive adhesive layer 80. The separator 91 protects the surface of the pressure sensitive adhesive layer 80 until the optical laminate is bonded to the image display cell. As a constituent material for the separator 91, a plastic film such an acrylic film, a polyolefin film, a cyclic polyolefin film or a polyester film is preferably used.

The thickness of the separator 91 is normally about 5 to 200 μm, preferably 10 to 60 μm, more preferably 15 to 40 μm, further preferably 20 to 30 μm. Preferably the surface of the separator 91 is subjected to release treatment. Examples of the release agent include silicone-based materials, fluorine-based materials, long-chain alkyl-based materials and fatty acid amide-based materials. The film used as the base material for forming the pressure sensitive adhesive layer 80 may be used as a separator as it is.

<Surface Protective Film>

As shown in FIG. 2, a surface protective film 92 may be temporarily attached on a surface of the glass layer 10 of the optical laminate. A surface protective film may also be temporarily attached in the optical laminate having the configuration shown in FIGS. 4 to 27.

The surface protective film 92 protects the glass layer 10 and the like until the optical laminate is used. Since the surface protective film 92 is temporarily attached to the surface of the glass layer 10, for example, generation of scratches, holes and the like can be prevented even when an object with a sharp tip falls onto the optical laminate.

As a material for the surface protective film 92, a plastic material similar to that fir the separator 91 is preferably used. In particular, a polyester-based resin such as polyethylene terephthalate or a (meth)acryl-based resin such as polymethyl methacrylate is preferable, with a polyethylene terephthalate resin being especially preferable, because of its high protective effect for the glass layer. Preferably, the surface protective film 92 has a pressure sensitive adhesive layer on a surface which is provided with the glass layer 10. As the surface protective film 92, a self-pressure sensitive adhesive film obtained by laminating a film-forming resin layer and a pressure sensitive adhesive layer by coextrusion may be used.

The thickness of the surface protective film 92 is, for example, about 20 μm to 1000 μm, preferably 30 to 500 μm, more preferably 40 to 200 μm, further preferably 50 to 150 μm.

<Decorative Printed Portion>

The optical laminate may include a decorative printed portion. FIG. 6A is a plan view showing an embodiment of an optical laminate having a decorative printed portion 15, and FIG. 6B is a sectional view of the optical laminate in the width direction. In the optical laminate 113, a frame-shaped decorative print is applied to a surface of the glass layer 10, and the transparent film 20 is disposed on a surface of the glass layer 10 where the decorative printed portion 15 is formed.

In the optical laminate having a frame-shaped decorative print as shown in FIG. 6A, one frame-shaped region corresponds to the size of one image display device. When a region having a decorative print is placed on the peripheral edge of a screen in the image display device, lead wiring etc. is prevented from being viewed from outside, resulting in contribution to improvement of the design property. A decorative printed portion may be provided for indication of the position of a switch etc., decoration and the like in addition to light shielding at the peripheral edge portion of a screen as described above.

The print thickness in the decorative printed portion is, for example, about 5 to 100 μm. For filling voids on the per of a printing level difference of the decorative printed portion 15 arranged on the surface of the glass layer 10, an adhesive layer or a pressure sensitive adhesive layer (not shown) may be disposed between the glass layer 10 and the optical film 20.

The decorative printed portion may be formed on any surface of the glass layer 10. In addition, a decorative printed portion may be formed on a constituent member of the optical Laminate other than the glass layer. For example, a decorative print may be applied to the polarizer 30 or the transparent film 20. By laminating a transparent film having a decorative printed portion (decorative printed film) to a constituent member of the optical laminate by a roll-to-roll method, an optical laminate having a decorative printed portion can also be obtained.

<Second Transparent Film>

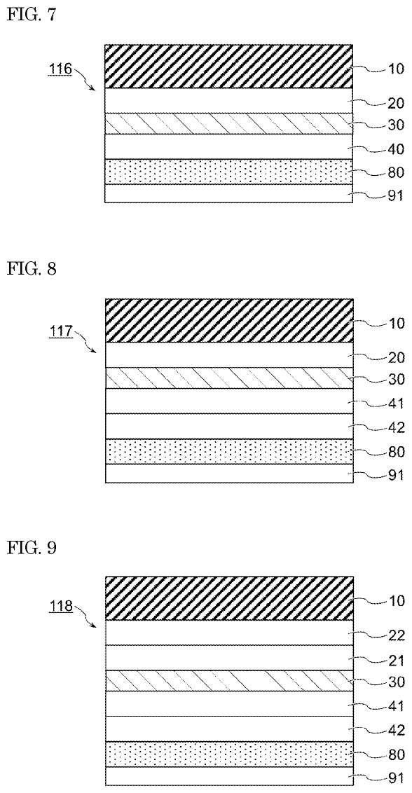

As shown in FIG. 7, the optical laminate may include a transparent film 40 between the polarizer 30 and the pressure sensitive adhesive layer 80. By arranging the transparent film 40 adjacent to the polarizer 30, the durability of the polarizer can be further improved. As shown in FIG. 8, a plurality of transparent films 41 and 42 may be disposed as second transparent films between the polarizer 30 and the pressure sensitive adhesive layer 80. As shown in FIG. 9, a plurality of transparent films 41 and 42 may be disposed as second transparent films between the polarizer 30 and the pressure sensitive adhesive layer 80, and a plurality of transparent films 21 and 22 may be disposed as first transparent films between the polarizer 30 and the glass layer 10.

The material, thickness, optical properties and the like of the second transparent films disposed between the polarizer 30 and the pressure sensitive adhesive layer 80 may be the same as described above for the first transparent films disposed between the polarizer 30 and the glass layer 10. The second transparent film may be an optically isotropic film or an optically anisotropic film. Use of optically anisotropic films as the second transparent films enables exhibition of various functions.

For example, when the image display cell 1 is an OLED cell, a quarter wave plate is used as the transparent film 40, and the transparent film 40 and the polarizer 30 constitute a circularly polarizing plate, external light reflected by metal electrodes of an OLED element cell, etc. can be blocked to improve visibility of display. As the transparent film 40, an obliquely stretched film may be used.

When the image display cell 1 is a liquid crystal cell, various optical compensations can be performed by using an optically anisotropic film as the transparent film 40. The type of the optically anisotropic, film used for optical compensation may be appropriately selected according to the type of the liquid crystal cell or the like.

For example, for optical compensation of a VA-type liquid crystal cell, an optically anisotropic element having a refractive index anisotropy of nx>nz>ny, and an optically anisotropic element having a refractive index anisotropy of nx>ny≈nz (positive A plate), an optically anisotropic element having a refractive index anisotropy of nx>ny>nz (negative B plate), an optically anisotropic element having a refractive, index anisotropy of nx≈ny>nz (negative C plate), or the like is used. These optically anisotropic elements are disposed in such a manner that the slow axis direction has an angle of 0° or 90° with respect to the direction of the absorption axis of the polarizer 30. This arrangement is effective for compensation of the phase difference of a liquid crystal in the thickness direction in addition to compensation of crossing angle deviation of polarizers viewed from an oblique direction. Two or more optically anisotropic elements may be laminated to impart the above-mentioned optical anisotropy to the transparent film.

For optical compensation of the TN-type liquid crystal cell, an optically anisotropic element having obliquely oriented optical axis is preferably used. An oriented liquid crystal film in which the oblique direction of the optical axis changes along the thickness direction is also preferably used. The optically anisotropic element having obliquely oriented optical axis performs a function of view angle compensation for on-state TN liquid crystal.

For optical compensation of the IPS-type liquid crystal cell, an optically anisotropic element satisfying the relationship of nx>nz>ny is preferably used (e.g. Japanese Patent No. 3687854 and Japanese Patent No. 5519423). By arranging an optically anisotropic element satisfying the relationship of nx>nz>ny in such a manner that the slow axis direction has an angle of 0° or 90° with respect to the direction of the absorption axis of the polarizer 30, it is possible to compensate the deviation of crossing angle of polarizers viewed from an oblique direction.

Two or more layers different in optical anisotropy may be laminated to form an optically anisotropic element having the relationship of nx>nz>ny. Examples of the laminated structure include combinations of an optically anisotropic element satisfying the relationship of nx>ny>nz (negative B plate) and an optically anisotropic element satisfying the relationship nz>nx>ny (positive B plate) (e.g. Japanese Patent No. 4938632 and Japanese Patent No. 6159290); combinations of the negative B plate and an optically anisotropic element satisfying the relationship of nz>nx≈ny (positive C plate) (e.g. Japanese Patent No. 4907993); combinations of an optically anisotropic element satisfying the relationship of nx>ny≈nz (positive A plate) and the positive C plate (Japanese Patent No. 3880996); combinations of the positive A plate and the positive B plate (e.g. Japanese Patent No. 2006-071964); combinations of the negative C plate and the positive B plate (e.g. Japanese Patent No. 4855081); combinations of the negative B plate and an optically anisotropic element satisfying the relationship of nz≈nx>ny (negative A plate) (e.g. Japanese Patent No. 4689286); and compositions of the negative C plate and the negative A plate (e.g. Japanese Patent No. 4253259).

<Adhesive Layer>

Preferably the glass layer, the transparent film and the polarizer are laminated with adhesive layers (not shown) interposed between the layers. Examples of the material that forms the adhesive include thermosetting resins and active energy ray-curable resins. Specific examples of the resins include epoxy-based resins, silicone-based resins, acryl-based resins, polyurethane, polyamide, polyether and polyvinyl alcohol. The adhesive may contain a polymerization initiator, a crosslinker, an ultraviolet absorber, a silane coupling agent, and the like.

The thickness of the adhesive layer is preferably 10 μm or less, more preferably 0.05 μm to 8 μm, further preferably 0.1 to 7 μm. When the thickness of the adhesive layer used for bonding the glass layer and the transparent film, the glass layer and the polarizer, or the polarizer and the transparent film is in the above-described range, breakage of the glass layer is suppressed, and thus an optical laminate excellent in impact resistance can be obtained. An adhesive may be used for bonding the transparent films.

<Functional Layer>

The optical laminate may have various functional layers other than those described above. Examples of the functional layer include antireflection layers, antifouling layers, light diffusion layers, easily-adhesive layers and antistatic layers.

(Antireflection Layer)

Examples of the antireflection layer include thin layer type in which reflection is prevented by utilizing an effect of eliminating reflected light under the multiple interference of light, and one in which the reflectance is reduced by providing minute structures on the surface. By arranging an antireflection layer on the second principal surface of the glass layer 10, reflection of external light can be prevented to improve visibility. Specific examples of the antireflection layer utilizing multiple interference of light include alternate laminates of a high-refractive-index layer composed of titanium oxide, zirconium oxide, niobium oxide or the like and a low-refractive-index layer composed of silicon oxide, magnesium fluoride or the like. Such a thin-film may be disposed directly on the glass layer 10, or disposed on the glass layer 10 with another layer interposed between the thin-film and the glass layer 10. The thickness of the antireflection layer is, for example, about 0.01 to 2 μm, preferably 0.05 to 1.5 μm.

### (Antifouling Layer)

Each member that forms the optical laminate may have an antifouling layer. In particular, since the glass layer 10 disposed on the outermost surface of the image display device is easily affected by contamination from the external environment (fingerprint, grime, dust and the like), it is preferable that the antifouling layer is formed on the second principal surface of the glass layer 10. Examples of the material for the antifouling layer include fluorine group-containing silane-based compounds and fluorine group-containing organic compounds. In addition, diamond-like carbon or the like can be used as a material for the antifouling layer. For enhancing the contamination prevention property and the contaminant removal property, the contact angle of the antifouling layer with pure water is preferably 100° or more, more preferably 102° or more, further preferably 105° or more. The thickness of the antifouling layer is, for example, about 0.01 to 2 μm, preferably 0.05 to 1.5 μm.

The second principal surface of the glass layer 10 may be provided with both an antireflection layer and an antifouling layer. When an antireflection layer and an antifouling layer are provided, it is preferable that the antireflection layer is formed on the glass layer 10, and the antifouling layer as an outermost layer is formed on the antireflection layer. For maintaining the antireflection property of the antireflection layer, the refractive index difference between the antifouling layer and the outermost layer of the antireflection layer is preferably small.

### (Light Diffusion Layer)

A light diffusion layer may be disposed on the optical laminate for the purpose of, for example, widening the view angle and preventing coloring of collected light. The light diffusion layer is preferably one with small back scattering. The haze of the light diffusion layer is preferably from 20 to 88%, more preferably 30 to 75%. As the light diffusion layer, for example, a diffusion pressure sensitive adhesive layer is used. For the diffusion pressure sensitive adhesive layer, a layer in which particles having different refractive indices are mixed in a polymer that forms the pressure sensitive adhesive, or the like is used.

The arrangement of the light diffusion layer in the optical laminate is not particularly limited, and for example, the light diffusion layer may be arranged on a viewing-side surface of the polarizer 30, a viewing-side surface of the transparent film 20 or a viewing-side surface of the glass layer 10 (second principal surface). The light diffusion layer may be arranged between the polarizer 10 and the pressure sensitive adhesive layer 80. Use of the diffusion pressure sensitive adhesive layer as the pressure sensitive adhesive layer 80 enables incorporation of the light diffusion layer in the optical laminate.

Instead of providing the light diffusion layer, or in addition to providing the light diffusion layer, a surface of the glass layer, the transparent film, the polarizer or the like may be subjected to antiglare treatment. Examples of the antiglare treatment include methods in which fine irregular structures are imparted to the surface by, for example, roughening the surface by sandblasting or embossing, blending transparent fine particles.

### (Easily-Adhesive Layer)

An easily-adhesive layer may be disposed on the surfaces of the glass layer 10, the transparent film 20, the polarizer 30 and the like for the purpose of improving wettability and adhesion to an adhesive or the like. Examples of the material for the easily-adhesive layer include epoxy-based resins, isocyanate-based resins, polyurethane-based resins, polyester-based resins, polymers containing an amino group in the molecule, ester urethane-based resins, and acryl-based resins having an oxazoline group. The thickness of the easily-adhesive layer is, for example, 0.05 to 3 μm, preferably 0.1 to 1

### (Antistatic Layer)

An antistatic layer may be disposed on the surfaces of the glass layer, the transparent film, the polarizer and the like. As the antistatic layer, one obtained by adding an antistatic agent to a binder resin is preferably used. Examples of the antistatic agent include ionic surfactants, conductive polymers such as polyaniline, polythiophene, polypyrrole and polyquinoxaline, and metal oxides such as tin oxide, antimony oxide and indium oxide. In particular, conductive polymers are preferably used from the viewpoint of optical properties, the appearance, the antistatic effect and the like. Among them, water-soluble or water-dispersible conductive polymers such as polyaniline and polythiophene are preferable.

The thickness of the antistatic layer is, for example, 0.01 to 2 μm, preferably 0.05 to 1 μm. An antistatic agent may be incorporated in a binder resin for the easily-adhesive layer to form an easily-adhesive layer having an antistatic property.

<Method for Manufacturing Optical Laminate Roll>

An optical laminated body roll can be obtained by laminating a long-band-shaped glass layer, a transparent film, a polarizer and the like by a roll-to-roll method, and winding the laminate around an appropriate core. The roll-to-roll lamination refers to a method in which long flexible films are aligned in the longitudinal direction and continuously laminated while being conveyed by a roll. Thin-films such as the antireflection layer and the antifouling layer may be formed on a substrate by a sputtering method, an ion plating method, a CVD method or the like while transporting the substrate by a roll-to-roll method.

The lamination order is not particularly limited. For example, the transparent film 20, the polarizer 30 and the like may be sequentially laminated onto the glass layer 10, or a laminate obtained by laminating a plurality of films in advance may be laminated to a glass layer by roll-to-roll. For lamination, an adhesive may be used as necessary, with the adhesive cured after lamination.

The method for curing the adhesive can be appropriately selected according to the type of the adhesive. When the adhesive is a photocurable adhesive, curing is performed by ultraviolet irradiation. The conditions for ultraviolet irradiation can be appropriately selected according to type of the adhesive, the composition of the adhesive composition, and the like. The accumulated amount of light is, for example, 100 to 2000 mJ/cm². When the adhesive is a thermosetting adhesive, curing is performed by heating. The heating conditions can be appropriately selected according to type of the adhesive, the composition of the adhesive composition, and the like. For the heating conditions, for example, the temperature is 50° C. to 200° C., and the heating time is about 30 seconds to 30 minutes.

While the glass layer 10 has high hardness and excellent impact resistance, very small cracks are easily generated at the end portions (end surfaces) of the glass layer 10. When bending stress is applied to the glass layer, the stress is concentrated on cracks, so that the cracks may extend, leading to breakage of the glass layer. In preparation of an optical laminate by roll-to-roll, a glass layer or a laminate including a glass layer is bent along the outer periphery of a conveyance roll when passing thereover, so that bending stress is applied to the glass layer. In a continuous roll of a glass layer or a laminate, a state is maintained in which bending stress is applied to the glass layer. Thus, at the time of conveyance by roll-to-roll and storage of the continuous roll, crack are easily generated due to bending stress of the glass layer, and the cracks may cause breakage of the glass layer.

For obtaining a long optical laminate having a length of 100 m or more, it is important to prevent breakage due to bending of the glass layer. For preventing breakage of the glass layer due to bending, it is preferable that number of cracks on the end surface throughout and continuously in the longitudinal direction is small, and good end surface quality is obtained at the time of winding the glass layer or the optical laminate into a roll. The number of cracks having a length of 3 μm or more on the end surface of the glass layer is preferably 5 or less, more preferably 1 or less, further preferably 0.5 or less per 1 m in the longitudinal direction. The length of the crack is a distance between the end surface of the glass layer and the tip of the crack in the width direction.

Even when the number of cracks at the end portion of the glass layer in the width direction is small, breakage easily occurs if the cracks have a large length. Thus, when cracks are generated on the end surface of the glass layer, it is preferable that cracks having a length exceeding 300 μm are not present over a distance of 10 m or more in the longitudinal direction, and it is more preferable that cracks having a length exceeding 300 μm are not present over a distance of 100 m or more in the longitudinal direction. The maximum value of the crack length in observation of the end surface of the glass layer over a distance of 10 m in the longitudinal direction is preferably 300 μm or less, more preferably 100 μm or less, further preferably 50 μm or less.

As described above, for obtaining a glass layer having a small number of cracks and good end surface quality, it is preferable that generation of cracks is prevented or crack generation areas are removed. Examples of the method for preventing generation of cracks or removing cracks include continuous temporary cutting by laser, scribe cutting, water jetting or dicing, and polishing processing typified by polishing. Two or more of the above-mentioned methods may be appropriately selected according to a combination of the glass and the optical laminate, and used in combination to prevent generation of cracks and/or remove cracks.

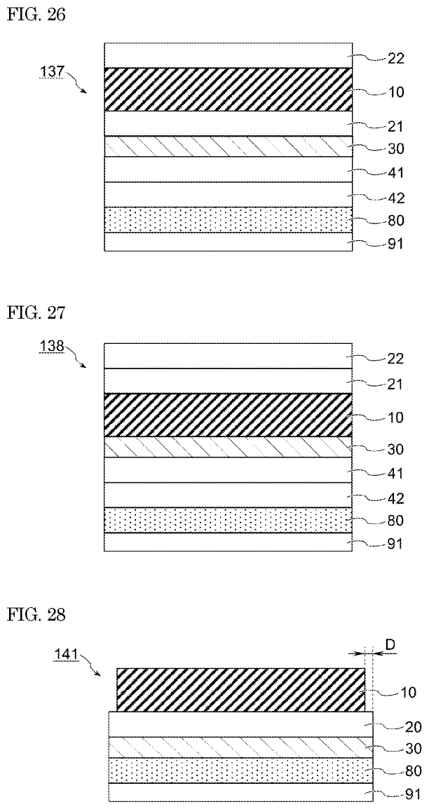

In an optical laminate roll obtained by winding the optical laminate into a roll, the end surface of the glass layer may be positioned inside the optical laminate roll. For example, when as in a laminate 141 shown in FIG. 28, the transparent film 20, the polarizer 30, the pressure sensitive adhesive layer 80 and the separator 91 laminated on the glass layer 10 have a width larger than that of the glass layer 10, and protrude outside both ends of the glass layer 10 in the width direction, the end surface of the glass layer is positioned inside the end surface of the roll in the optical laminate roll. The end surface of the glass layer 10 is not exposed, and therefore even when physical contact with the end surface of the roll occurs, other films and the pressure sensitive adhesive layer serve as cushions, so that direct damage to the glass layer can be avoided to suppress generation of cracks in the glass layer and breakage.

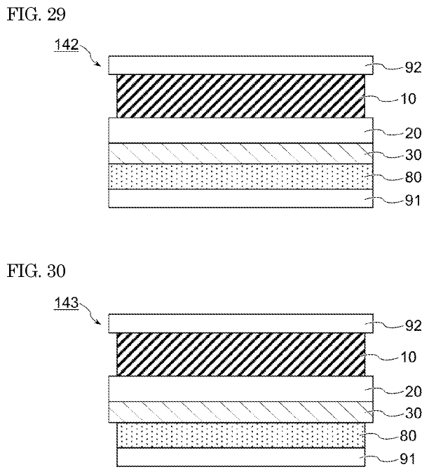

When the surface protective film 92 is temporarily attached to the surface of the glass layer 10, the surface protective film 92 may be disposed so as to protrude outside both ends in the width direction of the glass layer 10 as in a laminate 142 shown in FIG. 29. It is not necessary that all of the films and the pressure sensitive adhesive layer laminated on the glass layer 10 protrude outside the glass layer 10. For example, in a laminate 143 shown in FIG. 30, the surface protective film 92, the transparent film 20 and the polarizer 30 have a width larger than that of the glass layer 10 and protrude to both ends, and the pressure sensitive adhesive layer 80 and the separator 91 have a width equal to the width of the layer 10.

When the end surface of the glass layer is positioned inside the end surface of the optical laminate roll, the distance D between the end surface of the roll and the end surface of the glass layer is 1 mm or more, 3 mm or more, 5 mm or more, 7 mm or more, 10 mm or more, 15 mm or more, or 20 mm or more. The effect of preventing breakage of the glass layer by the cushioning action tends to be enhanced as the distance D between the end surface of the roll and the end surface of the glass layer increases. On the other hand, since the portion of the films and the pressure sensitive adhesive protruding from the end of glass layer is not included in the effective product region of the laminate, the cost may increase due to loss of materials when the distance D is excessively large. The distance D between the end surface of the roll and the end surface of the glass layer may be 200 mm or less, 100 mm or less, 70 mm or less, or 50 mm or less.

As described above, the width of the optical laminate is, for example, 0 to 3000 mm, preferably 10 to 2000 mm. The ratio of the width of the glass layer to the width of the optical laminate roll (width of a member having the largest width among optical elements that form the laminate) is, for example, 85 to 100%, preferably 90 to 99%, more preferably 95 to 98%.

As described above, the length of the optical laminate is 100 m or more, preferably 300 m or more, more preferably 500 m or more, further preferably 700 m or more. The effect of preventing breakage of the glass layer by positioning the end surface of the glass layer inside the end surface of the optical laminate roll tends to become more remarkable as the length of the optical laminate increases.

For preventing breakage of the glass layer due to extension of cracks, a measure for preventing the extension of cracks may be taken. For example, even when a crack having a large length is present at the end portion of the glass layer, breakage of the glass layer caused by the crack can be prevented by taking a measures for preventing extension of cracks. The above-described prevention of generation of cracks and/or removal of cracks may be combined with prevention of extension of cracks.

For preventing extension of cracks generated on the end surface of the glass layer, it is preferable to provide crack extension preventing means on a surface of the glass layer. For example, by bonding a resin film to a surface of the glass layer with an adhesive interposed therebetween, extension of cracks in the width direction due to bending can be suppressed. Even when a crack extends in the width direction from the end portion of the glass layer, extension of the crack is stopped by the adhesive due to elastic deformation of the adhesive as long as the resin film is bonded to the tip of the extended crack with the adhesive interposed therebetween.

Preferably, the crack extension preventing means is disposed at least at both ends of the glass layer in the width direction or in the vicinity of both ends of the glass layer in the width direction. The crack extension preventing means may be disposed over the entire glass layer in the width direction. Extension of cracks can be prevented by, for example, disposing a surface protective film 92 over the entire second principal surface of the glass layer 10 with the adhesive interposed therebetween as shown in FIG. 2. When the surface protective film 92 is disposed over the entire glass layer 10 in the width direction to prevent extension of cracks, the width of the surface protective film 92 is preferably 80% to 110%, more preferably 90% 100%, of the width of the glass layer 10.

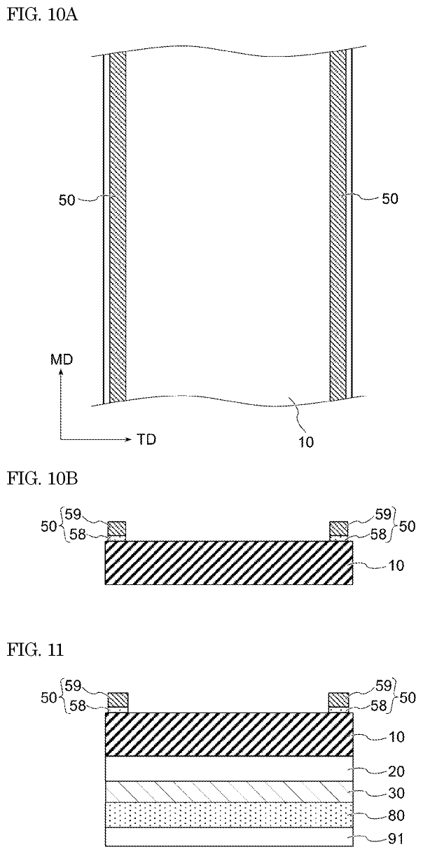

When the crack extension preventing means is disposed at the end portion of the glass layer in the width direction, it is preferable that tape-like crack extension preventing means 50 obtained by laminating a resin film 59 and an adhesive layer 58 are arranged in the vicinity of both end portions of the glass layer 10 in the width direction in a state of being separated from each other. FIG. 10A is a plan view of the glass layer 10 provided with a tape 50 as crack extension preventing means in the vicinity of both end portions in the width direction (TD), and FIG. 10B is a sectional view of the glass layer 10 in the width direction.

At least two tapes 50 are arranged in parallel to the longitudinal direction (MD) of the glass layer 10. Three or more tapes may be provided. The width of the tape 50 is not particularly limited, and may be an appropriate width. From the viewpoint of reliably preventing extension of cracks, the width of the tape 50 is preferably 10 mm or more, more preferably 20 mm or more. The width of the tape 50 is preferably 1 to 20%, more preferably 3 to 15%, of the width of the glass layer 10.

The resin film 59 of the tape 50 can be formed of any appropriate resin material. Specific examples of the resin material that forms the resin film 59 include polyethylene, polyvinyl chloride, polyethylene terephthalate, polyvinylidene chloride, polypropylene, polyvinyl alcohol, polyester, polycarbonate, polystyrene, polyacrylonitrile, ethylene-vinyl acetate copolymers, ethylene-vinyl alcohol copolymers, ethylene-methacrylic acid copolymers, nylon, cellophane and silicone resins.

The Young's modulus of the resin film 59 is preferably 0.1 to 20 GPa, more preferably 0.5 to 10 GPa, further preferably 2 to 5 GPa. The thickness of the resin film 59 is preferably 2 to 200 μm, more preferably 10 to 150 μm, further preferably 20 to 100 μm. In the resin film 59, the product of the thickness and the Young's modulus of the resin film 59 is preferably 100×10 Pa³ Pa m or more.

Examples of constituent materials for the adhesive layer 58 of the tape 50 include epoxy-based adhesives, acryl-based adhesives and urethane-based adhesives. The adhesive layer 58 may be a pressure sensitive adhesive layer. Examples of the pressure sensitive adhesive include rubber-based pressure sensitive adhesives, acryl-based pressure sensitive adhesives, silicone-based pressure sensitive adhesives and urethane-based pressure sensitive adhesives. A curable pressure sensitive adhesive or adhesive may be used. The thickness of the adhesive layer 58 is preferably 0.5 to 50 μm, more preferably 1 to 20 μm, from the viewpoint of dispersing stress by elastic deformation of the adhesive to prevent extension of cracks.

The creep amount of the adhesive layer 58 is preferably 50 μm/N 48 hr or less, more preferably 40 μm/N 48 hr or less. The creep amount of the adhesive is a creep amount in application of a tensile shear load of 5 g/mm² to the adhesive layer of the resin film for 48 hours with the resin film 59 fixed on the glass layer with the adhesive layer 58 interposed therebetween in an environment at 23° C. and 50% RH. The adhesive layer is disposed between the a PET film of 10 mm×30 mm and a glass plate in such a manner that the bonded surface has a size of 10 mm×10 mm, and the thus-obtained laminate is autoclaved at 50° C. and 50 atm for 15 minutes, and then left standing at room temperature (23° C.) for 1 hour to prepare a sample for measurement of the creep amount. This sample is loaded with tensile shear stress in a vertically downward direction by applying a load of 5/mm², and the amount of displacement of the sample after 48 hours is measured to determine the creep amount.

The slip constant S of the adhesive layer 58 is preferably 2×10⁻¹⁶ m²·48 hr or less. The slip constant S is defined as a product of α and σ (S=ασ), where α is a constant (m²/GPa·48 hr) representing slipperiness, and σ is surface stress of the glass layer 10 as an adherend. The constant α is defined as a ratio of a to F (α=a/F), where a is a creep amount in application of a tensile shear load for 48 hours, and F is a tensile shear load per unit area of an adhesive 48, which is applied to a resin film 49, with the glass layer 10 fixed in an environment at 23° C. and 50% RH. The surface stress σ is calculated from the expression α=Et/2r, where E is a Young's modulus of the glass layer 10, t is a thickness of the glass layer 10, and r is a curvature radius of the glass layer 10.

The slip constant S is inversely proportional to the curvature radius r of the glass layer 10, and the smaller the radius of curvature r, the larger the slip constant S. In the glass layer 10 or a continuous roll including the glass layer 10, the curvature radius at a position close to the core (inside the roll) is the smallest. Therefore, the slip constant S of the adhesive layer 58 is preferably 2×10⁻¹⁶m²·48 hr or less when the curvature radius r is a diameter R of a core around which a glass layer or a laminate including a glass layer is wound.

In preparation of the optical laminate roll, disposing crack extension preventing means such as the tape 50 on the glass layer 10 can be performed at any time. From the viewpoint of preventing breakage of the glass layer in the process of manufacturing the optical laminate and in storage of a product in process, it is preferable to dispose crack extension preventing means on a surface of the glass layer 10 before lamination to a transparent film or the like.

When a transparent film or a polarizer is laminated to the first principal surface of the glass layer 10, it is preferable to dispose crack extension preventing means on the second principal surface of the glass layer 10. The crack extension preventing means may be peeled and removed after lamination of the transparent film or the like to one surface of the glass layer 10. The crack extension preventing means may remain on the surface of the glass layer 10 after lamination of the transparent film or the like to the surface of the glass layer 10. For example, as shown in FIG. 11, the tape 50 as crack extension preventing means may be attached on the second principal surface of the glass layer 10 after formation of the optical laminate, and crack extension preventing means may be arranged on a surface of the glass layer in the optical laminate roll.

The crack extension preventing means may be disposed on both surfaces of the glass layer 10, or may be disposed so as to cover the end surface of the glass layer 10. For example, by bonding a tape from both sides of the glass layer so as to cover the end portions of both principal surfaces of the glass layer in the width direction and the end surface of the glass layer, the crack extension preventing means is disposed so as to cover the end surface of the glass layer.

<Characteristics of Optical Laminate>

The optical laminate of the first embodiment includes the glass layer 10, and therefore has high hardness. In addition, the optical laminate includes resin films such as the transparent film 20 and the polarizer 10 on the first principal surface of the glass layer 10, so that breakage of the glass layer 10 is prevented to exhibit excellent impact resistance. This is because impacts applied to the second principal surface (viewing-side surface) can be effectively released to the first principal surface side (polarizer 30 side). Impact resistance is remarkably improved particularly when the polarizer 30 is disposed on the first principal surface of the glass layer 10 with the transparent film 20 interposed therebetween. Loss caused by breakage of the glass layer during transportation and storage of the optical laminate roll can be dramatically reduced by suppressing generation of cracks on the end surface or extension of cracks to the end surface as described above. In addition, since the glass layer is hardly broken, it is possible to decrease the thickness of the glass layer, and the weight of the optical laminate can be accordingly reduced.

Further, a glass material has high moisture and gas shielding properties, high durability against organic solvents, acids, alkalis and the like, and excellent heat resistance. Therefore, by disposing the glass layer 10 on the surface, protection performance for the polarizer 30 can be improved to prevent degradation of the polarizer as compared to a case where only the resin film 20 is present. In the configuration of the first embodiment, since the glass layer 10 and the polarizer 30 protect each other, it is possible to decrease the amount of protective members, so that the weight and the thickness of the optical laminate can be reduced.

The glass material has a surface gloss, and therefore by disposing the glass layer 10 on a surface of the image display device, an excellent glare feeling can be obtained. In addition, the glass material is optically isotropic, and therefore coloring of reflected light hardly occurs, so that high visibility can be attained. Further, the glass layer 10 has high surface hardness, and is thus excellent in impact resistance. Thus, when the optical laminate is bonded to the image display cell in such a manner that the glass layer 10 forms a viewing-side surface, the glass layer 10 performs a function as a front window, so that it is not necessary to place a window layer separately. Therefore, the process of manufacturing the image display device can be simplified, and the thickness and the weight of the device can be reduced due to reduction of the number of constituent members.

The glass layer 10 has a higher Young's modulus higher bending rigidity as compared to resin film materials. Thus, the optical laminate is hardly curled, has high rigidity even after being cut into sized sheets, and is therefore excellent in handleability. In addition, even when the optical laminate is stored in the form of a continuous roll for a long period of time, defects caused by curl and the like hardly occur, so that the yield can be improved. The optical laminate roll of the present invention has high applicability to a roll-to-panel process in which a sheet is unwound from a continuous roll, and bonded to an image display cell while being cut into sized sheets.

### Second Embodiment

In the first embodiment, a configuration has been shown in which a polarizer and a pressure sensitive adhesive layer are sequentially disposed on a first principal surface of a flexible glass layer. As long as the optical laminate in the optical laminate roll of the present invention has a glass layer, a polarizer and a pressure sensitive adhesive layer, stacking order thereof is not particularly limited. For example, in the optical laminate roll according to a second embodiment of the present invention, the pressure sensitive adhesive layer is arranged on a first principal surface of a glass layer and a polarizer is arranged on a second principal surface of the glass layer.

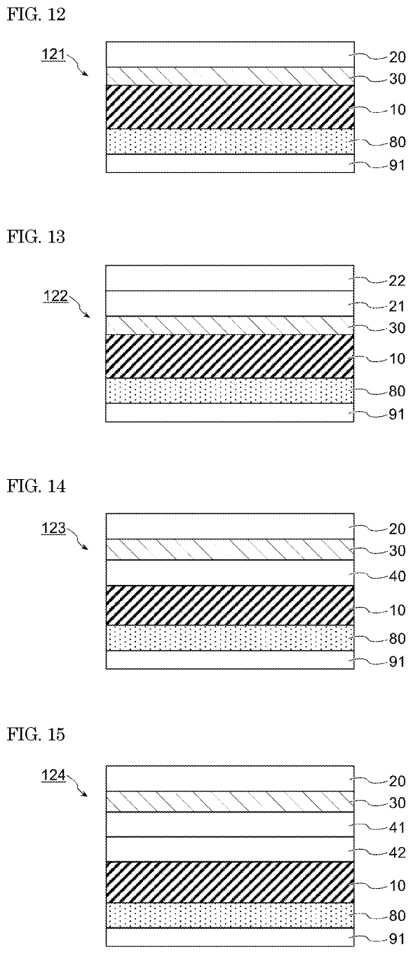

FIG. 12 is a sectional view showing an example of a stacking configuration of the optical laminate according to the second embodiment. The optical laminate 121 in FIG. 12 includes a pressure sensitive adhesive layer 80 on a first principal surface of a glass layer, and a polarizer 30 and a transparent film 20 are sequentially disposed on a second principal surface of the glass layer 10. In this stacking configuration, one surface of the polarizer 30 is protected by the glass layer 10, and the other surface of the polarizer 30 is protected by the transparent film 20, so that high protection performance for the polarizer 30 can be attained to prevent degradation of the polarizer.

In the second embodiment, the constituent material and the thickness of each of the glass layer, the transparent film, the polarizer and the like are the same as in the first embodiment. It is preferable that the layers are bonded with an appropriate adhesive. As in the first embodiment, the surface of each layer may have functional layers such as an antireflection layer, an antifouling layer, a light diffusion layer, an easily-adhesive layer and an antistatic layer.

The transparent film 20 may be an optically anisotropic film such as an obliquely stretched quarter wave plate. As in an optical laminate 122 shown in FIG. 13, a plurality of transparent films 21 and 22 may be disposed on the polarizer 30.

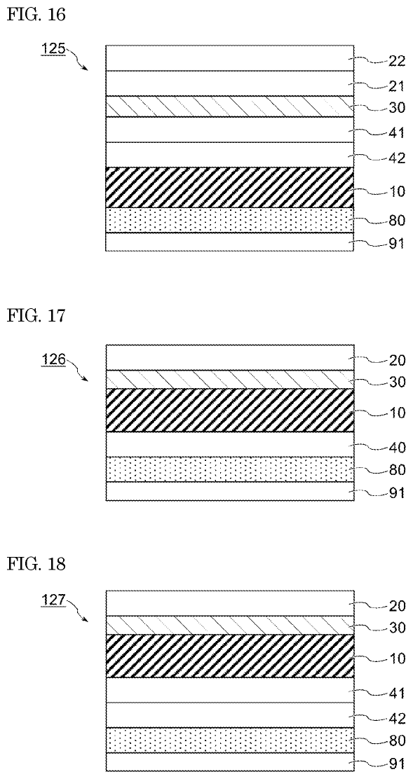

As shown in FIG. 14, a second transparent film 40 may be disposed between the polarizer 30 and the glass layer 10. As shown in FIG. 15, the second transparent film may include a plurality of transparent films 41 and 42. As in an optical laminate 125 shown in FIG. 16, a plurality of transparent films 21 and 22 may be disposed on the polarizer 30, and a plurality of transparent films 41 and 42 may be disposed between the polarizer 30 and the glass layer 10.

The second transparent film arranged between the polarizer 30 and the glass layer 10 has a function of protecting the polarizer 30. As in the first embodiment, the second transparent film may have functions of preventing reflection of external light in an OLED display, optical compensation in a liquid crystal display, and the like.

In the optical laminates 121 to 125 shown in FIGS. 12 to 16, a pressure sensitive adhesive layer is disposed adjacent to the glass layer 10. When image display devices are formed using these optical laminates, the image display cell 1 is bonded to the optical laminate with the pressure sensitive adhesive layer 80 interposed therebetween, where the pressure sensitive adhesive layer 80 is arranged on the second principal surface of the glass layer 10. In general, inorganic materials such as glass plates are arranged on the surfaces of the image display cell 1, and therefore the pressure sensitive adhesive layer 80 is used for bonding inorganic materials. Thus, the material design for the pressure sensitive adhesive layer 80 is easy.

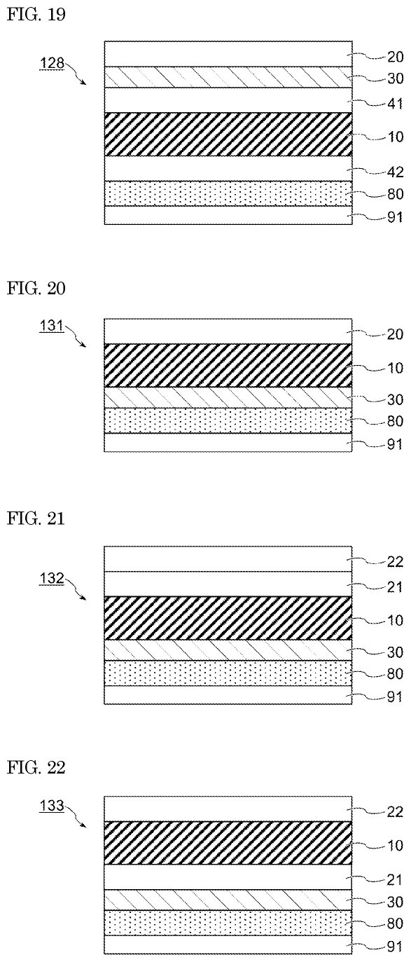

As in an optical laminate 126 shown in FIG. 17, the second transparent film 40 may be disposed between the glass layer 10 and the pressure sensitive adhesive layer 80. As in an optical laminate 127 shown in FIG. 18, a plurality of transparent films 41 and 42 may be disposed between the glass layer 10 and the pressure sensitive adhesive layer 80. As in an optical laminate 128 shown in FIG. 19, the transparent film 41 may be disposed between the polarizer 30 and the glass layer 10, and the transparent film 42 may be disposed between the glass layer 10 and the pressure sensitive adhesive layer 80. In the optical laminate 128 in FIG. 19, each of the transparent film 20, the transparent film 41 and the transparent film 42 may be a single layer, or may include a plurality of films.

### Third Embodiment

In an optical laminate roll according to a third embodiment of the present invention, an optical laminate includes a polarizer and a pressure sensitive adhesive layer on a first principal surface of a glass layer, and a transparent film on a second principal surface of the glass layer.

FIG. 20 is a sectional view showing an example of a stacking configuration of the optical laminate according to the third embodiment.. The optical laminate 131 in FIG. 20 includes a polarizer 30 and a pressure sensitive adhesive layer 80 on a first principal surface of a glass layer 10, and a transparent film 20 on a second principal surface of the glass layer 10. In this stacking configuration, impact resistance tends to be improved by disposing a resin films on both surfaces of the glass layer 10.

In the third embodiment, the constituent material and the thickness of each of the glass layer, the transparent film, the polarizer and the like are the same as in the first embodiment. It is preferable that the layers are bonded with an appropriate adhesive. As in the first embodiment, the surface of each layer may be provided with functional layers such as an antireflection layer, an antifouling layer, a light diffusion layer, an easily-adhesive layer and an antistatic layer.

The transparent film 20 may be an optically anisotropic film such as an obliquely stretched quarter wave plate. As in an optical laminate 132 shown in FIG. 21, a plurality of transparent films 21 and 22 may be disposed on the second principal surface of the glass layer 10. As in an optical laminate 133 shown in FIG. 22, the transparent film 22 may be disposed on the second principal surface of the glass layer 10, and the transparent film 21 may be disposed between the glass layer 10 and the polarizer 30.

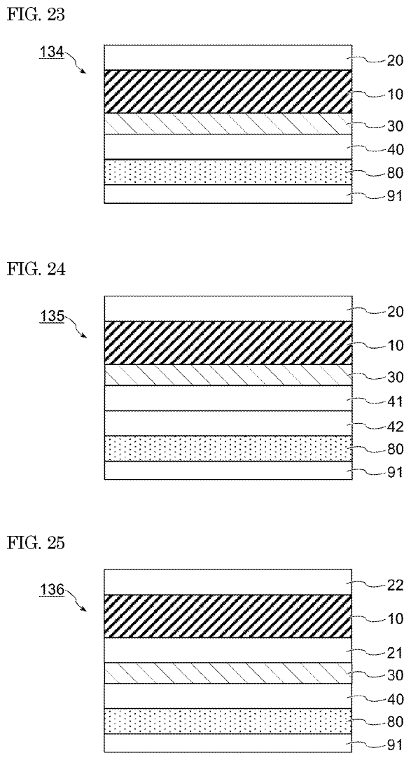

As in an optical laminate 134 shown in FIG. 23, the second transparent film 40 may be disposed between the polarizer 30 and the pressure sensitive adhesive layer 80. As shown in FIG. 24, the second transparent film may include a plurality of transparent films 41 and 42. The second transparent film arranged between the polarizer 30 and the pressure sensitive adhesive layer 80 has a function of protecting the polarizer 30. As in the first embodiment, the second transparent film may have functions of preventing reflection of external light in an OLED display, optical compensation in a liquid crystal display, and the like.

Even when the second transparent film 40 is arranged between the polarizer 30 and the pressure sensitive adhesive layer 80, the transparent film 22 may be disposed on the second principal surface of the glass layer 10 and the transparent film 21 may be disposed between the glass layer 10 and the polarizer 30 as in an optical laminate 136 shown in FIG. 25. As in an optical laminate 137 shown in FIG. 26, the transparent film 20 may be disposed on the second principal surface of the glass layer 10, the transparent film 21 may be disposed between the glass layer 10 and the polarizer 30, and a plurality of transparent films 41 and 42 may be disposed between the polarizer 30 and the pressure sensitive adhesive layer 80. As in an optical laminate 138 shown in FIG. 27, a plurality of transparent films 21 and 22 may be disposed on the second principal surface of the glass layer 10, and a plurality of transparent films 41 and 42 may be disposed between the polarizer 30 and the pressure sensitive adhesive layer 80. Further, one or more transparent films may also be disposed between the glass layer 10 and the polarizer 30.

### Formation of Image Display Device

The optical laminate is used for forming an image display device. In formation of the image display device, the separator 91 temporarily attached on a surface of the pressure sensitive adhesive layer 80 may be peeled, followed by bonding the optical laminate to a surface of the image display cell 1. Preferably, the optical laminate is bonded to a viewing-side surface of the image display cell. The optical laminate may be bonded to the back surface of the image display cell.

In formation of the image display device, sized sheets of the optical laminate, each of which have the same size as that of the image display device, are cut out from the optical laminate roll. Cutting of the optical laminate roll into the sized sheets may be performed in advance. The long optical laminate may be unwound from the roll, and bonded to the image display cell while being cut into sized sheets.

After the image display cell is bonded to the optical laminate, a transparent member such as a front window may be disposed on the optical laminate if necessary. The optical laminate of the first embodiment has the glass layer 10 disposed on a surface thereof, so that placement of the front window may be omitted.

### DESCRIPTION OF REFERENCE CHARACTERS

10 glass layer

30 polarizer

20, 21, 22 transparent film (first transparent film)

40, 41, 42 transparent film (second transparent film)

80 pressure sensitive adhesive layer

91 separator

99 surface protective film

111, 112, 114 to 118 optical laminate

121 to 128 optical laminate

131 to 138 optical laminate

1 image display cell

501 image display device

50 tape (crack extension preventing means)

58 adhesive layer

59 resin film

1. An optical laminate roll formed of a long optical laminate, the optical laminate comprising: a flexible glass layer, a polarizer and a pressure sensitive adhesive layer, wherein
a thickness of the glass layer is 150 μm or less, and
a length of the optical laminate is 100 m or more.

2. The optical laminate roll according to claim 1, wherein the polarizer has a thickness of 3 to 25 μm.

3. The optical laminate roll according to claim 1, wherein the pressure sensitive adhesive layer has a thickness of 10 to 30 μm.

4. The optical laminate roll according to claim 1, wherein at least one of the polarizer and the pressure sensitive adhesive layer has a width larger than a width of the glass layer, and protrudes from both ends of the glass layer in the width direction.

5. The optical laminate roll according to claim 1, further comprising a separator temporarily attached on a surface of the pressure sensitive adhesive layer.

6. The optical laminate roll according to claim 5, wherein the separator has a thickness of 10 to 60 μm.

7. The optical laminate roll according to claim 5, wherein the separator has a width larger than a width of the glass layer, and protrudes from both ends of the glass layer in the width direction.

8. The optical laminate roll according to claim 1, wherein the polarizer and the pressure sensitive adhesive layer are arranged in this order on a first principal surface of the glass layer.

9. The optical laminate roll according to claim 8, further comprising a first transparent film between the glass layer and the polarizer.

10. The optical laminate roll according to claim 9, wherein the glass layer and the first transparent film are bonded together with an adhesive layer interposed therebetween.

11. The optical laminate roll according to claim 10, wherein the adhesive layer has a thickness of 10 μm or less.

12. The optical laminate roll according to claim 9, wherein the first transparent film is an obliquely stretched quarter wave plate.

13. The optical laminate roll according to claim 9, wherein the first transparent film is an optically isotropic film.

14. The optical laminate roll according to claim 9, wherein the first transparent film has a width larger than a width of the glass layer, and protrudes from both ends of the glass layer in the width direction.

15. The optical laminate roll according to claim 8, further comprising a second transparent film between the polarizer and the pressure sensitive adhesive layer.

16. The optical laminate roll according to claim 15, wherein the second transparent film is an optically anisotropic element.

17. The optical laminate roll according to claim 16, wherein the optically anisotropic element includes an obliquely stretched quarter wave plate.

18. The optical laminate roll according to claim 16, wherein the optically anisotropic element includes two or more layers having different optical anisotropy.

19. The optical laminate roll according to claim 15, wherein the second transparent film has a width larger than a width of the glass layer, and protrudes from both ends of the glass layer in the width direction.

20. The optical laminate roll according to any one of claim 8, further comprising an antireflection layer on a second principal surface of the glass layer.

21. The optical laminate roll according to claim 8, further comprising an antifouling layer on a second principal surface of the glass layer.

22. The optical laminate roll according to claim 8, further comprising an antistatic layer on a first principal surface or second principal surface of the glass layer.

23. The optical laminate roll according to claim 8, further comprising an easily-adhesive on a surface of any of the polarizer, the first transparent film and the second transparent film.

24. The optical laminate roll according to claim 8, further comprising a light diffusion layer.

25. The optical laminate roll according to claim 8, further comprising a surface protective layer temporarily attached on a second principal surface of the glass layer.

26. The optical laminate roll according to claim 25, wherein the surface protective film has a thickness of 40 to 200 μm.

27. The optical laminate roll according to claim 8, further comprising a crack extension preventing means on a second principal surface of the glass layer.

28. The optical laminate roll according to claim 27, wherein the crack extension preventing means includes a resin film and an adhesive layer, and the adhesive layer is bonded to the second principal surface of the glass layer.

29. The optical laminate roll according to claim 27, wherein the crack extension preventing means is arranged at both end portions of the optical laminate in the width direction or in the vicinity of both end portions of the optical laminate in the width direction.

30. The optical laminate roll according to claim 8, further comprising a first transparent film on a second principal surface of the glass layer.

31. The optical laminate roll according to claim 30, wherein the first transparent film has a width larger than a width of the glass layer, and protrudes from both ends of the glass layer in the width direction.

32. The optical laminate roll according to claim 1, wherein in the optical laminate, the pressure sensitive adhesive layer is arranged on a first principal surface of the glass layer and the polarizer is arranged on a second principal surface of the glass layer.
